(19) United States
(12) Patent Application Publication
(10) Pub. No.: US 2013/0155078 A1
(43) Pub. Date: Jun. 20, 2013

(54) CONFIGURABLE GRAPHICS CONTROL AND MONITORING

(71) Applicant: Behrooz Karimian-Kakolaki, Newmarket (CA)

(72) Inventor: Behrooz Karimian-Kakolaki, Newmarket (CA)

(73) Assignee: ATI TECHNOLOGIES ULC, Markham (CA)

(21) Appl. No.: 13/327,067

(22) Filed: Dec. 15, 2011

(51) Int. Cl. G06F 13/14; G06T 1/00

(52) U.S. Cl. 345/520; 345/501

(57) ABSTRACT

A method and a graphics control and monitoring system are described. The graphics control and monitoring system is configurable and is equipped with a control and processing device, a computer, a data acquisition device, and a display. The control and processing device is equipped with a field programmable device that is configurable to work with a variety of data acquisition devices. The control and processing device receives data collected by the data acquisition device and processes the data. Further, graphics processing is performed by the processor which can be a central processing unit (CPU), a graphics processing unit (GPU), general purpose computation on GPU (GPGPU) that is equipped with parallel computation capability, among others. After processing, display data is provided to a display.

### FIELD OF THE INVENTION

The present invention is generally directed to configurable graphics control and monitoring.

### BACKGROUND

Large-scale electronics systems such as airborne flight control systems, radar signal processing systems, aerospace systems, medical imaging systems, and broadcast control systems typically generate large data streams from sensors and customized processing blocks. These data streams typically include high volume graphics and image data that require customized control and complex user interfaces. Large scale electronics systems also require custom-designed hardware and software interfaces for processing, controlling and displaying the system's data streams. Furthermore, because these large-scale electronic systems typically occur in low-volume, the cost of that associated hardware and software development is usually very high. Furthermore, the customization of the hardware/software functions sometimes results in a user interface lacking real-time visualization and ergonomic design.

It is, therefore, desirable to have a configurable control and monitoring system for controlling, processing, visualizing, and monitoring large-scale electronics systems. It is further desirable for the configurable system to ready to operate with a variety of electronics systems without major hardware or software modification.

### SUMMARY OF EMBODIMENTS OF THE INVENTION

Embodiments of a method and a graphics control and monitoring system are provided. In the method and system, data collected by a data acquisition device is provided to a control and processing device. The control and processing device processes the collected data at a first processing stage to produce first stage processed data. First stage processed data is further processed at a second processing stage to produce display data. Further in the method and system, display data is transmitted to a display. Also in the method and apparatus the collected data may be video data, audio data, or other general-purpose data.

In one embodiment, the first processing stage may include physical layer processing and in another embodiment, the second processing stage may include graphics processing. Further, the control and processing device may be coupled to the data acquisition device via a low-voltage differential signaling (LVDS) interface, a transmission-minimized differential signaling (TMDS) interface, or a parallel single ended low-voltage transistor-transistor logic (LVTTL) bus.

### BRIEF DESCRIPTION OF THE DRAWINGS

A more detailed understanding may be had from the following description, given by way of example in conjunction with the accompanying drawings, wherein:

FIG. 1 is a block diagram of a configurable graphics control and monitoring system;

FIG. 2 is a block diagram of an embodiment of a control and processing device;

FIG. 3 is a block diagram of the software modules of a controller; and

FIG. 4 is a block diagram of the software modules of processor.

### DETAILED DESCRIPTION OF EMBODIMENTS

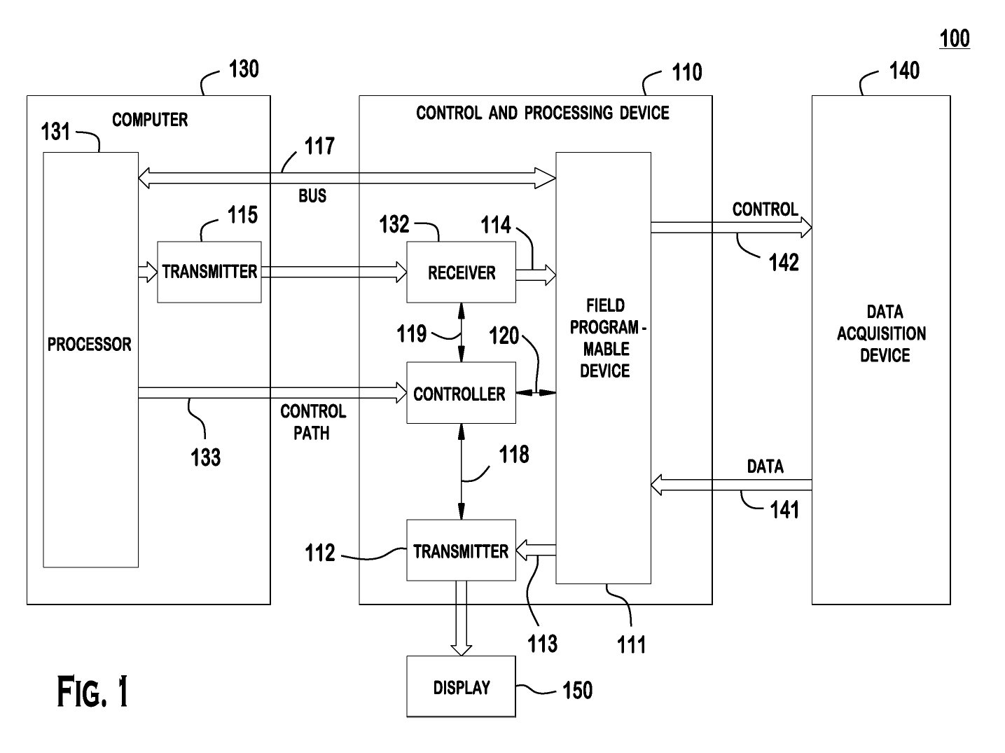

FIG. 1 is a block diagram of a configurable graphics control and monitoring system 100. The configurable graphics control and monitoring system 100 is equipped with a control and processing device 110, a computer 130, a data acquisition device 140, and a display 150.

The data acquisition device 140 collects data generated from sensors, cameras, or any customized data processing blocks. For example, the data acquisition device 140 may be part of a road traffic broadcast system that collects video feeds generated from multiple cameras that are arranged to report road traffic videos in a geographical area. The data acquisition device 140 provides collected data to the control and processing device 110 over data path 141. The collected data may be audio data, video data, or any other general-purpose data.

The data acquisition device 140 receives control information from the control and processing device 110 over control path 142, where the control information configures the data acquisition device 140. For example, the data acquisition device 140 may be configured using the control information to cease feeding video from a certain camera or to cause that camera to rotate by a certain number of degrees in order to provide a different view of the traffic in the area.

The control and processing device 110 is equipped with a field programmable device 111. The field programmable device 111, which may be a field programmable gate array (FPGA), has internal logic that is software-configurable, thereby allowing for flexibility in its function. The field programmable device is, therefore, not restricted by a predetermined hardware. The field programmable device 111 receives data from the data acquisition device 140 over data path 141 and sends control information to the data acquisition device 140 over data control path 142 using any digital interface protocol. By way of example, such protocols may be low-voltage differential signaling (LVDS), or transmission-minimized differential signaling (TMDS). Further, the digital interface may be a parallel single ended low-voltage transistor-transistor logic (LVTTL) bus.

The field programmable device 111 is advantageous in that it is configurable, whereby the interface over which the field programmable device 111 sends control information and receives data from the data acquisition device 140 is configurable depending on the capabilities or requirements of the data acquisition device 140. For example, the field programmable device 111 may be configured to use an LVDS interface to interface with a data acquisition system 140 of the road traffic broadcast system described. However, when used, for example, with a radar processing system that utilizes a TDMS interface, the field programmable device 111 may be reconfigured to use a TDMS interface. As such, the control and processing device 110 has the flexibility to work with a variety of data acquisition systems.

The field programmable device 111 may perform a variety of functions on received data from the data acquisition device 140, including physical layer functions, such as decoding, demultiplexing, parity check operations, or clock recovery operations. The field programmable device 111 may also perform higher-layer graphics processing functionality, such as color space conversion, anti-aliasing, shading, or rasterization, among others, on received data. After processing, the field programmable device 111 may output processed data over an interface 113 to transmitter 112. The transmitter 112 may be high-definition multimedia interface (HDMI) protocol-compliant, or DisplayPort (DP) protocol-compliant, among others. Further, the transmitter 112 may transmit audio data, video data, or any other type of data. The transmitter 112 transmits the processed data in accordance with the transmitter's protocol, (e.g., HDMI, or DP), to a similarly compliant display 150. The display 150 may, for example, be a control room display where video, audio, and other types of data collected by data acquisition system 140 are displayed.

The field programmable device 111 is also equipped with a bus 114 by which the field programmable device 111 interfaces with processor 131 of computer 130. The bus 114 may be a Peripheral Component Interface (PCI) bus, or a PCI Express (PCIE) bus, among others that are known in the art. The field programmable device 111 may transfer data to the processor 131 over the bus 114. The processor 131 may be a central processing unit (CPU), graphics processing unit (GPU), an integrated processing unit having both graphics and general purpose computing capabilities in what is known in the art as an accelerated processing unit (APU). The processor 131 may also be a GPU that is capable of performing general purpose computing tasks in what is known in the art as general purpose computation on GPU (GPGPU).

The data sent by field programmable device 111 to the processor 131 may be further processed by the processor 131. In one example, the processing performed by the field programmable device 111 and by the processor 131 complement each other, whereby the field programmable device 111 performs physical layer processing on graphics data received from the data acquisition device 140 and the processor 131 performs graphics processing functions. Graphics processing functions may entail computationally intensive operations for which processor 131 is better equipped than the field programmable device 111. By way of example, a GPGPU having parallel computing capability may be better equipped to perform graphics processing functionality than a field programmable device.

The processor 131 may run data processing algorithms on the data received over bus 114. The data processing algorithms may be different depending on the requirements of a particular graphics control and monitoring system 100. For example, the processing performed on data pertaining to a road traffic broadcast system may be different than that performed on data pertaining to a radar system. The processor is configurable to run data processing algorithms on received data and output display information to display 150 as desired.

The processor 131 may run a graphical user interface (GUI) allowing a user to control the data processing algorithms performed by the processor 131. Further, the GUI may allow the user to control the control and processing device 110 and control display information that is outputted to display 150. The GUI allows a user, for example, to select video feeds to be displayed on display 150. Further, the GUI allows the user to adjust the resolution of displayed video, zoom on certain parts, send control information to the data acquisition system 140 to change camera view, to begin providing video from a specific camera, or cease providing video from another camera.

Control information intended to the data acquisition device 140 may be sent by the processor 131 to the field programmable device 131 via bus 114. The field programmable device may then send control information to the data acquisition device 140 over control path 142.

Following processing, the processor 131 provides data that is ready for display to a transmitter 132. The transmitter 132 transmits the data to a receiver 115 of the control and processing device 110. The receiver 115 provides the data to the field programmable device 111 over interface 117. The field programmable device 111 provides the data over interface 113 to transmitter 112. The transmitter 112 provides the data to display 115. Similar to transmitter 112, transmitter 132 and receiver 115 may be HDMI or DP-compliant. In one embodiment, the control and processing device 110 may transmit data directly to display 150 without providing the data to the field programmable device 111. In another embodiment, computer 130 may transmit data directly to the display 150.

The control and processing device 110 is further equipped with a controller 116. The controller 116 controls transmitter 112 and receiver 115. The controller 116 receives control information from processor 131 over control path 133 which may, for example, be a Universal Serial Bus (USB) interface, or a recommended standard 232 (RS-232) interface. The controller 116 ensures that transmitter 112 and receiver 115 operate as desired. The controller initializes the transmitter and receiver for operation, updates their firmware, and receives interrupt signals from the transmitter and receiver, among other tasks.

The controller 116 may have software modules that include drivers for the transmitter and receiver. The drivers allow the controller to issue commands to the transmitter or receiver. Further, the drivers are responsible for ensuring interoperability between both the controller and the transmitter or the receiver.

The controller 116 communicates with transmitter 112 over interface 118 and communicates with receiver 115 over interface 119. Interfaces 118, 119 may include an inter-integrated circuit (I2C) bus when transmitter 112 or receiver 115 is HDMI-compliant. Furthermore, interfaces 118, 119 may include a universal asynchronous receiver/transmitter (UART) bus when transmitter 112 or receiver 115 is DP-compliant.

Although as shown in FIG. 1 the controller 116 is separate from the field programmable device 111, it will be recognized that in other embodiments the functionality of the controller 116 may be implemented as a part of the field programmable device 116. Further, it is recognized that the control and processing device 110 may have memory associated with any of its components. The control and processing device 110 may also have a power source, a wake-on-LAN (local area network) device for turning the device on using a network message, or other peripheral components required for the operation of the control and processing device 110 in accordance with the embodiments described herein.

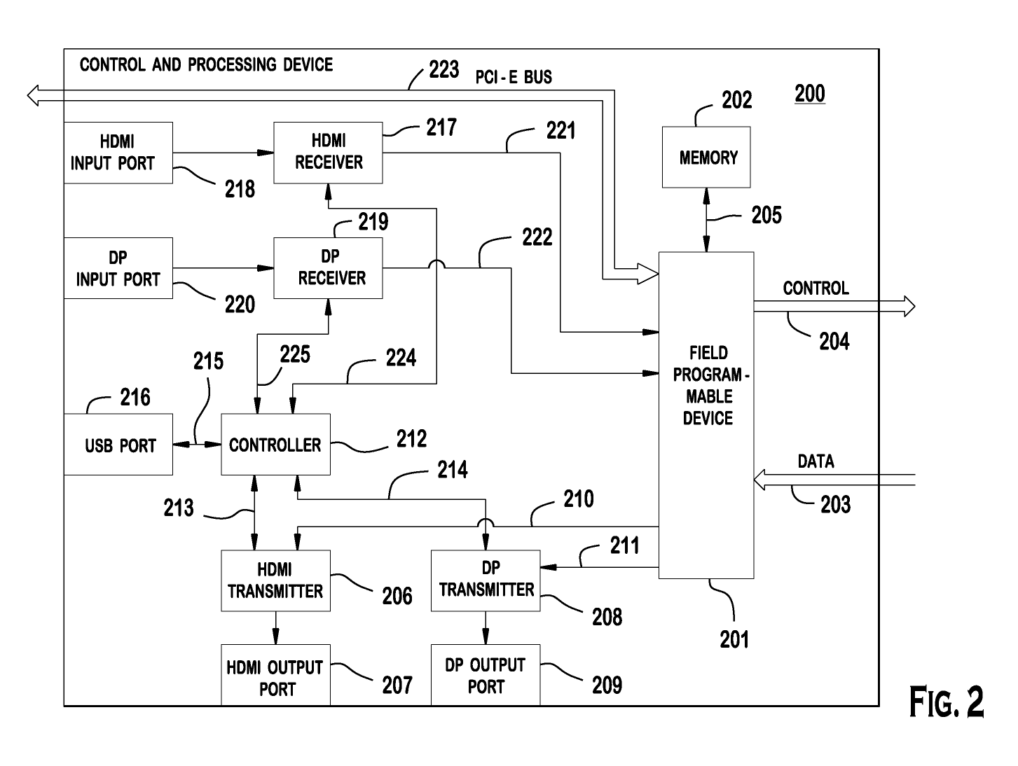

FIG. 2 shows a block diagram of an embodiment 200 of a control and processing device 110 equipped with HDMI and DP transmission and reception capabilities, a PCI-E bus for transmitting data to a computer and a USB interface for receiving control information from the computer. The control and processing device 200 in the embodiment of FIG. 2 has a field programmable device 201 that receives data over data path 203 and sends control information over control path 204. The field programmable device 201 is coupled to memory 202 via memory bus 205. The memory 202 is used for storing data and instructions upon which the field programmable device 201 may operate.

The control and processing device 200 is also equipped with an HDMI transmitter 206 that is connected to HDMI output port 207 for outputting data for display. Similarly, the control and processing device 200 is equipped with a DP transmitter 208 that is connected to DP output port 209 for outputting data for display. The HDMI transmitter 206 receives data from the field programmable device 201 over interface 210 and the DP transmitter receives data from the field programmable device 201 over interface 211.

The control and processing device is further equipped with an HDMI receiver 217 that is connected to HDMI input port 218 for receiving data for display. Similarly, the control and processing device 200 is equipped with a DP receiver 219 that is connected to DP input port 220 for receiving data for display. The HDMI receiver 217 sends data to the field programmable device 201 over interface 210 and the DP receiver sends data to the field programmable device 201 over interface 222. The control and processing device 200 of this embodiment also has PCI-E interface 223.

The control and processing device 200 is also equipped with a controller 212. The controller 212 runs software that enables the controller 212 to control the operation of the HDMI transmitter 206 using interface 213, the DP transmitter 208 over interface 214, the HDMI receiver 217 using interface 224, and the DP receiver 219 over interface 2225. The controller 212 may receive control information for controlling the operation of the HDMI and DP transmitters and receivers via interface 215 from USB port 216.

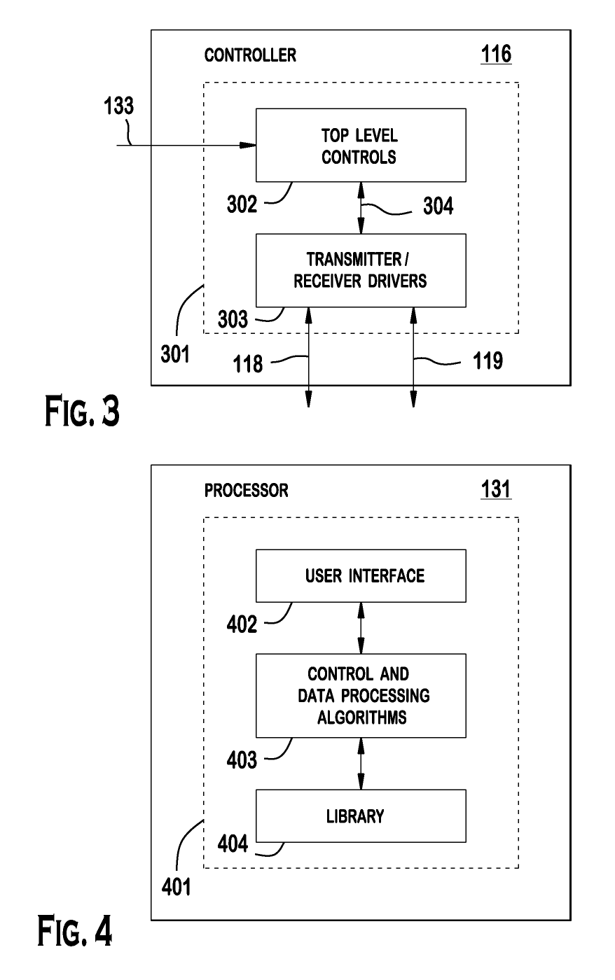

FIG. 3 shows a block diagram of the software modules 301 of controller 116 (FIG. 1). The software modules 301 include top-level controls 302 and transmitter and receiver drivers 303. The top-level controls 302 issue routines 304 to the transmitter and receiver drivers 303. The transmitter and receiver drivers 303 issue commands to the transmitter via interface 118 and to the receiver via interface 119 in accordance with the routines 304 issued by the top level controls 302. The controller 116 may issue routines in the drivers 303 based on its own software or commands it receives over interface 133 from computer 130.

The top level controls 302 may include a command handler which interacts with the drivers 303 through function calls as is known in the art. The command handler may receive commands through interface 133, process these commands and issue the commands as function calls. The top level controls 302 may also include an interrupt generator which receives interrupts generated by the transmitter or receiver and processes these interrupts. The interrupts may include a buffer overflow indicator which indicates that buffers of the receiver or transmitter are full or that certain packets were dropped by the receiver or transmitter. The top level controls 302 may also include sanity checks for the receiver or transmitter. The sanity checks may invoke routines to check whether the receiver or transmitter is responsive or operating properly. Furthermore, top-level controls 302 may include memory control for any memory associated with the transmitter or receiver.

FIG. 4 shows a block diagram of the software modules of processor 131. The software modules 401 include a user interface 402 that allows a user to control the operation of the configurable graphics control and monitoring system 100. The user interface allows for real-time visualization and an ergonomic interface for the user. The user interface 402 may cause the execution of control and data processing algorithms 403 by the processor 131. As previously described, the control and data processing algorithms 403 may include algorithms for processing of the data received from the data acquisition device 140 for display on display 150, control of the data acquisition device 140, or control of the elements of control and processing device 110.

The control and data processing algorithms 403 use a library 404 for their operations. The library 404 is a software library that includes customized code and sub-routines for facilitating interaction among the component of the configurable graphics control and monitoring system 100. The library 404 may include a resource management library that has code responsible for ensuring that memory space is available within the computer 130 for the processor 131 to store incoming data received across bus 114. As previously described, the received data may include video data including frame image data, audio data, or any other general-purpose data. The library 404 may also include a frame library that has code responsible for defining capture status settings for processor 131. Capture options include frame capture, a burst of frame capture, or continuous frame capture. Further, the frame library may have code that performs soft frame analysis on incoming data, whereby the frame library may be used for ratification of an incoming frame or comparing the incoming frame to a reference frame.

The library 404 may also include a management library for the control and processing device 110. The management library may include code for detecting the availability of field programmable device 111, controller 116, receiver 115, or transmitter 112 at start up or for setting their configuration. Further, the management library may include code for setting up a connection to controller 116 over control path 133, or for updating the firmware of controller 118 or any element of control and processing device 110 having its own firmware.

The library 404 may also include a graphics library for configuring transmitter 112 and receiver 115 of control and processing device 110. The graphics library may enable the configuration of content protection, and audio and video properties. For example, the graphics library may be equipped with software routines to configure transmitter 112 for outputting a certain resolution of video, enable or disable content protection, or mute or unmute audio. Further, the graphics library may be equipped with software routines to handle emulation and plug or unplug detection of the transmitter 112 or receiver 115.

Embodiments of the present invention may be represented as instructions and data stored in a computer-readable storage medium. For example, aspects of the present invention may be implemented using Verilog, which is a hardware description language (HDL). When processed, Verilog data instructions may generate other intermediary data, (e.g., netlists, GDS data, or the like), that may be used to perform a manufacturing process implemented in a semiconductor fabrication facility. The manufacturing process may be adapted to manufacture semiconductor devices (e.g., processors) that embody various aspects of the present invention.

Although features and elements are described above in particular combinations, each feature or element may be used alone without the other features and elements or in various combinations with or without other features and elements. The methods provided may be implemented in a general purpose computer, a processor or any IC that utilizes power gating functionality. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine. Such processors may be manufactured by configuring a manufacturing process using the results of processed hardware description language (HDL) instructions (such instructions capable of being stored on a computer readable media). The results of such processing may be maskworks that are then used in a semiconductor manufacturing process to manufacture a processor which implements aspects of the present invention.

What is claimed is:

1. A graphics control and monitoring system comprising:
a control and processing device for receiving data from a data acquisition device and for processing the received data at a first processing stage to produce first stage processed data, wherein the control and processing device is configurable for receiving the data from the data acquisition device via at least one of a plurality of types of interfaces;
a processor, coupled to the control and processing device, for receiving the first stage processed data and processing the first stage processed data at a second processing stage, wherein the processor outputs display data.

2. The graphics control and monitoring system of claim 1, further comprising:
a transmitter, coupled to the processor, for transmitting the display data.

3. The graphics control and monitoring system of claim 2, further comprising:
a display for receiving and displaying the display data.

4. The graphics control and monitoring system of claim 1 wherein the received data is video data, audio data, or other general-purpose data.

5. The graphics control and monitoring system of claim 1 wherein the first processing stage includes physical layer processing.

6. The graphics control and monitoring system of claim 1 wherein the second processing stage includes graphics processing.

7. The graphics control and monitoring system of claim 1 wherein the control and processing device comprises a transmitter for transmitting display data to the display

8. The graphics control and monitoring system of claim 1 wherein the at least one of a plurality of types of interfaces is a low-voltage differential signaling (LVDS) interface, a transmission-minimized differential signaling (TMDS) interface, or a parallel single ended low-voltage transistor-transistor logic (LVTTL) bus.

9. The graphics control and monitoring system of claim 7 wherein the control and processing device further comprises a receiver for receiving the display data from the processor.

10. The graphics control and monitoring system of claim 9 wherein the control and processing device further comprises a controller for controlling the transmitter and the receiver.

11. The graphics control and monitoring system of claim 10 wherein the controller is coupled to the processor via a Universal Serial Bus (USB) interface, or a recommended standard 232 (RS-232) interface

12. The graphics control and monitoring system of claim 10 wherein the controller receives information from the processor for controlling the transmitter and receiver.

13. A method for graphics control and monitoring comprising:
receiving, by a control and processing device, data from a data acquisition device, wherein the control and processing device is configurable for receiving the data from the data acquisition device via at least one of a plurality of types of interfaces;
processing the received data at a first processing stage to produce first stage processed data; and
processing the first stage processed data at a second processing stage to output display data.

14. The method of claim 13, further comprising:
transmitting display data to a display.

15. The method of claim 13 wherein the received data is video data, audio data, or other general-purpose data.

16. The method of claim 13 wherein the first processing stage includes physical layer processing.

17. The method of claim 13 wherein the second processing stage includes graphics processing.

18. The method of claim 14 wherein the display data is transmitted to the display transmitter in accordance with high-definition multimedia interface (HDMI), or DisplayPort (DP) protocol.

19. A computer-readable storage medium storing a set of instructions for execution by a general purpose computer for graphics control and monitoring, the set of instructions comprising:
a receiving code segment for receiving, by a control and processing device, data from a data acquisition device, wherein the control and processing device is configurable for receiving the data from the data acquisition device via at least one of a plurality of types of interfaces;
a first processing code segment for processing the received data at a first processing stage to produce first stage processed data; and
a second processing code segment for processing the first stage processed data at a second processing stage to output display data.

20. The computer readable storage medium of claim 19 wherein the set of instructions are hardware description language (HDL) instructions used for the manufacture of a device.
